(19) United States
(12) Patent Application Publication
(10) Pub. No.: US 2025/0370694 A1
(43) Pub. Date: Dec. 4, 2025

(54) SCREEN MIRRORING PROCESSING METHOD AND APPARATUS, DEVICE, AND STORAGE MEDIUM

(71) Applicant: Beijing Zitiao Network Technology Co., Ltd., Beijing (CN)

(72) Inventor: Ye TIAN, Beijing (CN)

(21) Appl. No.: 18/874,557

(22) PCT Filed: Aug. 28, 2023
(86) PCT No.: PCT/CN2023/115158

§ 371 Date: Dec. 12, 2024

(30) Foreign Application Priority Data
Aug. 26, 2022 (CN) 202211038032.1

(51) Int. Cl. G06F 3/14; H04N 21/2187; H04N 21/431

(52) U.S. Cl. CPC G06F 3/1454; H04N 21/2187; H04N 21/4316

(57) ABSTRACT

The present disclosure provides a screen mirroring processing method and apparatus, a device, and a storage medium. The method includes: in response to a trigger operation on a screen mirroring setting control for a target live-streaming page, acquiring a screen mirroring setting file corresponding to the target live-streaming page, the screen mirroring setting file including a mapping relationship between each live-streaming component and a screen mirroring status, and the screen mirroring status being a screen mirroring display status or a screen mirroring hidden status; and on the basis of the screen mirroring status corresponding to each live-streaming component in the screen mirroring setting file, controlling screen mirroring display of the target live-streaming page.

The present application claims the priority of Chinese patent application No. 202211038032.1 filed on Aug. 26, 2022, which is incorporated in the present application by reference in its entirety.

### TECHNICAL FIELD

Embodiments of the present disclosure relates to a screen projecting processing method, and a screen projecting processing apparatus, a screen projecting processing device, and a storage medium.

### BACKGROUND

Screen projecting refers to displaying content displayed on a smart device, such as mobile phone, tablet PC, or computer, on another device by a projecting way.

In a live streaming application scenario, in addition to live streaming images, a live-streaming room also has many live streaming related functional components (also called live-streaming room components, such as comment function components, and like function components) to enrich live streaming interaction functions.

At present, the function of screen projecting for a live-streaming room page is relatively simple, that is, all the contents on the live-streaming room page displayed on a screen projecting device are projected and displayed on the screen projected device, or only the live streaming images are subjected to screen projecting, which cannot meet the diverse functional needs of users for screen projecting in live streaming scenarios, thus affecting the screen projecting experience of the users.

### SUMMARY

In order to solve the above technical problems, the present disclosure provides a screen projecting processing method, and a screen projecting processing apparatus, a screen projecting processing device, and a storage medium.

In a first aspect, the present disclosure provides a screen projecting processing method, comprising: acquiring a screen projecting display setting file corresponding to a target live-streaming room page in response to a triggering operation for a screen projecting setting control of the target live-streaming room page, in which the screen projecting display setting file comprises a mapping relationship between each live-streaming room component and a screen projecting status, the screen projecting status is a screen projecting display status or a screen projecting hidden status; and controlling the target live-streaming room page to perform screen-projecting display based on the screen projecting status corresponding to the each live-streaming room component in the screen projecting display setting file.

In an optional implementation, the acquiring the screen projecting display setting file corresponding to the target live-streaming room page in response to the triggering operation for the screen projecting setting control of the target live-streaming room page comprises: displaying a status to be set of at least one live streaming component on the target live-streaming room page in response to the triggering operation for the screen projecting setting control of the target live-streaming room page; and acquiring the screen projecting display setting file corresponding to the target live-streaming room page in response to the screen projecting display setting operation for the status to be set of the at least one live-streaming room component.

In an optional implementation, the acquiring the screen projecting display setting file corresponding to the target live-streaming room page in response to the triggering operation for the screen projecting setting control of the target live-streaming room page comprises: acquiring the screen projecting display setting file corresponding to the target live-streaming room page from a preset cloud server in response to the triggering operation for the screen projecting setting control of the target live-streaming room page.

In an optional implementation, the controlling the target live-streaming room page to perform screen-projecting display based on the screen projecting status corresponding to the each live-streaming room component in the screen projecting display setting file comprises: in response to determine a current status being in a mirror screen projecting mode, drawing the target live-streaming room page based on the screen projecting status respectively corresponding to the live-streaming room components in the screen projecting display setting file, and obtaining a first drawing result; and transmitting the first drawing result to a screen projecting device, and the screen projecting device is used for displaying the first drawing result.

In an optional implementation, the controlling the target live-streaming room page to perform screen-projecting display based on the screen projecting status corresponding to the each live-streaming room component in the screen projecting display setting file comprises: in response to determine a current status being a digital living network alliance (DLNA) screen projecting mode, based on the screen projecting status corresponding to the each live-streaming room component in the screen projecting display setting file, acquiring a component drawing layer or a component screenshot of the target live-streaming room page according to a preset frequency, in which the live-streaming room component on the target live-streaming room page is drawn on the component drawing layer, and the component screenshot carries page location information; overlaying the collected live streaming image of the target live-streaming room page and the component drawing layer or the component screenshot, and obtaining an overlay result; and transmitting the overlay result to a preset streaming media server, and indicating the screen projecting device to pull the overlay result from the preset streaming media server based on a pre-acquired streaming media server address to display.

In an optional implementation, after acquiring the screen projecting display setting file corresponding to the target live-streaming room page in response to the screen projecting display setting operation for the status to be set of the at least one live-streaming room component, the screen projecting processing method further comprises: unloading the corresponding relationship between a current object identifier and the screen projecting display setting file to a preset cloud server; and the screen projecting display setting file is used for controlling screen projecting display of the live-streaming room page corresponding to an object with the current object identifier.

In an optional implementation, after acquiring the screen projecting display setting file corresponding to the target live-streaming room page in response to the screen projecting display setting operation for the status to be set of the at least one live-streaming room component, the screen projecting processing method further comprises: establishing a corresponding relationship between a live-streaming room type corresponding to the target live-streaming room page and the screen projecting display setting file; and unloading the live-streaming room type and the screen projecting display setting file having the corresponding relationship to a preset cloud server; and the screen projecting display setting file is used for controlling screen projecting display of the live-streaming room page corresponding to the live-streaming room type.

In an optional implementation, after acquiring the screen projecting display setting file corresponding to the target live-streaming room page in response to the screen projecting display setting operation for the status to be set of the at least one live-streaming room component, the screen projecting processing method further comprises: establishing a corresponding relationship between a live-streaming room identifier corresponding to the target live-streaming room page and the screen projecting display setting file; and uploading the live-streaming room identifier and screen projecting display setting file having the corresponding relationship to a preset cloud server; and the screen projecting display setting file is used for controlling the screen projecting display of the live-streaming room page with the live-streaming room identifier.

In an optional implementation, after controlling the target live-streaming room page to perform screen-projecting display based on the screen projecting status corresponding to the each live-streaming room component in the screen projecting display setting file, the screen projecting processing method further comprises: in response to a preset live-streaming room switching operation for the target live-streaming room page, switching and displaying the target live-streaming room page to a switched live-streaming room page corresponding to the preset live-streaming room switching operation; and controlling the switched live-streaming room page to perform screen-projecting display based on the screen projecting display setting file corresponding to the target live-streaming room page.

In a second aspect, the present disclosure provides a screen projecting processing apparatus, comprising: a first acquisition module configured to: acquire a screen projecting display setting file corresponding to a target live-streaming room page in response to a triggering operation for a screen projecting setting control of the target live-streaming room page, in which the screen projecting display setting file comprises a mapping relationship between each live-streaming room component and a screen projecting status, the screen projecting status is a screen projecting display status or a screen projecting hidden status; and a first control module configured to control the target live-streaming room page to perform screen-projecting display based on the screen projecting status corresponding to the each live-streaming room component in the screen projecting display setting file.

In a third aspect, the present disclosure provides a computer-readable storage medium, in which instructions are stored, a terminal device implements the above screen projecting processing methods upon the instructions running on the terminal device.

In a fourth aspect, the present disclosure provides a screen projecting processing device, comprising, a memory, a processor, and a computer program which is stored in the memory and can run in the processor, the above screen projecting processing methods are implemented upon the computer program being performed by the processor.

In a fifth aspect, the present disclosure provides a computer program product, comprising a computer program/instructions, and the above methods are implemented upon the computer program/instructions being executed by a processor.

### BRIEF DESCRIPTION OF THE DRAWINGS

The accompanying drawings herein are incorporated into and constitute a part of this specification, which illustrates the embodiments in conformity with the present application and serves to explain the principles of the present application together with the description.

To illustrate the embodiments of the present disclosure more clearly, the accompanying drawings which are required to describe the embodiments will be briefly described below. Apparently, for one of ordinary skill in the art, other drawings can be obtained on the basis of these drawings without any creative work.

FIG. 1 is a flowchart of a screen projecting processing method provided by an embodiment of the present disclosure;

FIG. 2 is a schematic diagram of a live-streaming room page provided by an embodiment of the present disclosure;

FIG. 3 is a schematic diagram of another live-streaming room page provided by an embodiment of the present disclosure;

FIG. 4 is a schematic diagram of a component circling selection page of a live-streaming room provided by an embodiment of the present disclosure;

FIG. 5 is a schematic diagram of another component circling selection page of a live-streaming room provided by an embodiment of the present disclosure;

FIG. 6 is a flowchart of DLNA screen projecting provided by an embodiment of the present disclosure;

FIG. 7 is a structural schematic diagram of a screen projecting processing apparatus provided by an embodiment of the present disclosure; and

FIG. 8 is a structural schematic diagram of a screen projecting processing device provided by an embodiment of the present disclosure.

### DETAILED DESCRIPTION

To understand the above objectives, features, and advantages more clearly, the scheme of the present application will be further described below. It is to be noted that, without conflicting with each other, the embodiments and features in embodiments of the present disclosure can be combined with each other.

Many particular details are set forth in the following description to sufficiently understand the present disclosure, but the present disclosure can be implemented by other ways than those described herein. Apparently, the embodiments in the description are merely some, not all embodiments of the present application.

Screen projecting refers to display content displayed on a smart device, such as mobile phone, tablet PC, or computer, on another device by a screen projecting way.

In a live streaming application scenario, in addition to live streaming images, a live-streaming room also has many live streaming related functional components (also called live-streaming room components, such as comment function components, and like function components) to enrich live streaming interaction functions.

At present, the function of screen projecting for a live-streaming room page is relatively simple, that is, all the contents on the live-streaming room page displayed on a screen projecting device are displayed on a screen projected device in a screen projecting way, or only the live streaming images are screen projected, which cannot meet the diverse functional needs of users for screen projecting in live streaming scenarios, thus affecting the screen projecting experience of the users.

Therefore, an embodiment of the present disclosure provides a screen projecting processing method. The method includes: firstly, in response to a triggering operation for a screen projecting setting control of a target live-streaming room page, acquiring a screen projecting display setting file corresponding to the target live-streaming room page, in which the screen projecting display setting file includes a mapping relationship between each live-streaming room component and a screen projecting status, the screen projecting status is a screen projecting display status or a screen projecting hidden status; and controlling the target live-streaming room page to perform screen-projecting display based on the screen projecting status corresponding to the each live-streaming room component in the screen projecting display setting file. In this way, in the embodiment of the present disclosure, based on the screen projecting status corresponding to the each live-streaming room component in the screen projecting display file corresponding to the target live-streaming room page, the screen projecting display of the target live-streaming room page can be controlled, the effect of screen projecting for the live-streaming room components in the live streaming scenario screen projecting function is enriched, and the screen projecting experience of the user in a live streaming scenario is improved.

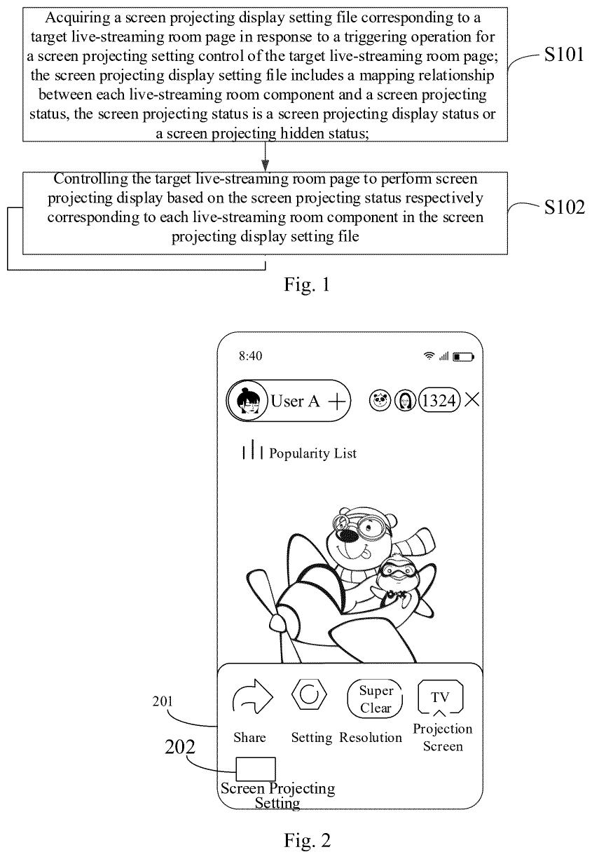

On this basis, an embodiment of the present disclosure provides a screen projecting processing method, referring to FIG. 1 which is a flowchart of screen projecting processing provided by an embodiment of the present disclosure, the method includes following steps.

S101, acquiring a screen projecting display setting file corresponding to a target live-streaming room page in response to a triggering operation for a screen projecting setting control of the target live-streaming room page.

The screen projecting display setting file includes a mapping relationship between each live-streaming room component and a screen projecting status, the screen projecting status is a screen projecting display status or a screen projecting hidden status.

The screen projecting processing method provided by the embodiment of the present disclosure is applied to a terminal device, which can be a smart phone, a Personal Digital Assistant (PDA), a Tablet Personal Computer (Tablet PC), a PMP (portable multimedia player), a vehicle-mounted terminal (such as a vehicle-mounted navigation terminal), a wearable device, a notebook computer and other mobile terminals, and fixed terminals, such as a digital television, a desktop computer, and a smart home device.

The target live-streaming room page refers to any live-streaming room page currently displayed by the terminal device, such as a shopping live-streaming room page, and a fitness live-streaming room page.

The screen projecting setting control is a preset screen projecting setting control, and can be specifically arranged on a function setting panel of the target live-streaming room page, and no limitation is made here by the present disclosure.

In the embodiment of the present disclosure, after the triggering operation for the screen projecting setting control of the target live-streaming room page is received, the screen projecting display setting file corresponding to the target live-streaming room page is acquired.

Referring to FIG. 2 which is a schematic diagram of a live-streaming room page provided by an embodiment of the present disclosure, in which a screen projecting setting control 202 is arranged on a function setting panel 201, after the triggering operation of the user for the screen projecting setting control 202 of the target live-streaming room page is received, the screen projecting display setting file corresponding to the target live-streaming room page can be acquired.

In an optional implementation, after the triggering operation for the screen projecting setting control of the target live-streaming room page is received, the screen projecting display setting file corresponding to the target live-streaming room page is acquired; the screen projecting setting control is configured to acquire the screen projecting display setting file corresponding to the target live-streaming room page, namely the screen projecting display setting file corresponding to at least part of live-streaming room components (functional components, such as a like button) of the target live-streaming room page. After the triggering operation for the screen projecting setting control of the target live-streaming room page is received, there are a plurality of modes for acquiring the screen projecting display setting file corresponding to the target live-streaming room page; in an optional implementation, in response to the triggering operation for the screen projecting setting control of the target live-streaming room page, a status to be set of at least one live streaming component on the target live-streaming room page is displayed (which can be a default status, for example, the default status can be the screen projecting display status or the screen projecting hidden status; the status can also be a status set last time, and the status set last time can also be the screen projecting display status or the screen projecting hidden status); and in response to the screen projecting display setting operation for the status to be set of the at least one live-streaming room component (for example, in response to the status to be set of the live-streaming room component 1 being the screen projecting display status, after the screen projecting display setting operation is carried out for the live-streaming room component 1, the screen projecting status of the live-streaming room component 1 is switched to the screen projecting hidden status), the screen projecting display setting file corresponding to the target live-streaming room page is acquired (correspondingly, the screen projecting status of the live-streaming room component 1 in the screen projecting display setting file is switched to the screen projecting hidden status).

In an optional implementation, in response to the triggering operation for the screen projecting setting control of the target live-streaming room page, a component setting list of the target live-streaming room is displayed, and the status to be set of at least one live-streaming room component on the target live-streaming room page is displayed in the component setting list; and in response to the screen projecting display setting operation for the status to be set of the at least one live-streaming room component, the screen projecting display setting file corresponding to the target live-streaming room page is generated.

The component setting list of the target live-streaming room can be displayed in a popup window form, and no limitation is made here by the present disclosure.

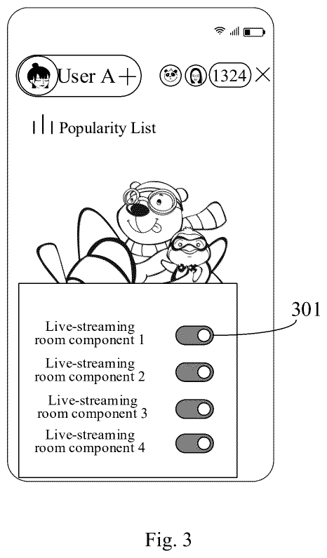

Continuously referring to FIG. 2, after the triggering operation for the screen projecting setting control 202 is received, the component setting list of the live-streaming room is displayed, as shown in FIG. 3, the live-streaming room components and corresponding switch buttons are displayed in the component setting list of the live-streaming room; the status to be set of each live-streaming room component can be represented by the corresponding switch button corresponding to the live-streaming room component, and the user can represent the screen projecting display setting operation of the status to be set of each live-streaming room component by the triggering operation on the corresponding switch button.

For example, the user can click or long press the switch button to switch the screen projecting status of the live-streaming room component; in an optional implementation, after the user clicks a switch button 301, after the user is prompted that the screen projecting of the live-streaming room component 1 is started, the screen projecting status is the screen projecting display status or the screen projecting hidden status, the screen projecting status of the live-streaming room component 1 is represented as the screen projecting display status, and the live-streaming room component 1 is in a display status, namely a visible status, on the target live-streaming room interface displayed after screen projecting. The screen projecting status of the live-streaming room component 1 is represented by the screen projecting hidden status, and the live-streaming room component 1 is represented as the hidden status, namely an invisible status, on the target live-streaming room interface displayed after screen projecting.

In an optional implementation, in response to the triggering operation for the screen projecting setting control of the target live-streaming room page, a component circling selection page of the target live-streaming room is displayed, and the component circling selection page displays the status to be set of the at least one live-streaming room component on the target live-streaming room page; and in response to the screen projecting display setting operation for the status to be set of the at least one live-streaming room component, the screen projecting display setting file corresponding to the target live-streaming room page is generated.

In the component circling selection page of the target live-streaming room, each live-streaming room component of the target live-streaming room page is displayed as a static image of a certain frame, and in order not to affect the user to watch a live streaming image, the live streaming image can be played in real time.

Specifically, after the triggering operation for the screen projecting setting control of the target live-streaming room page is received, the component circling selection page of the target live-streaming room is displayed, and a circling selection box of at least one live-streaming room component is displayed on the component circling selection page, in which the circling selection box is configured to identify screen projecting display setting of the status to be set of the circled live-streaming room component; and after the triggering operation for the circling selection box of the at least one live-streaming room component is received, the screen projecting display setting file corresponding to the target live-streaming room page is generated.

In the embodiment of the present disclosure, the circling selection status of the circling selection box is used for representing the status to be set of the live-streaming room component, and the user can represent the screen projecting display setting operation for the status to be set of the live-streaming room component through the triggering operation on the circling selection box.

It is to be noted that, after the user performs the triggering operation on the circling selection box, whether the screen projecting status of the corresponding live-streaming room component is the display screen projecting status or the hidden screen projecting status is not limited here by the present disclosure.

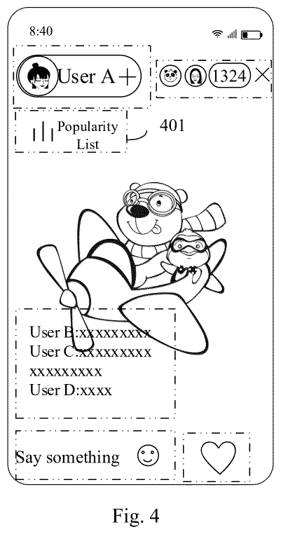

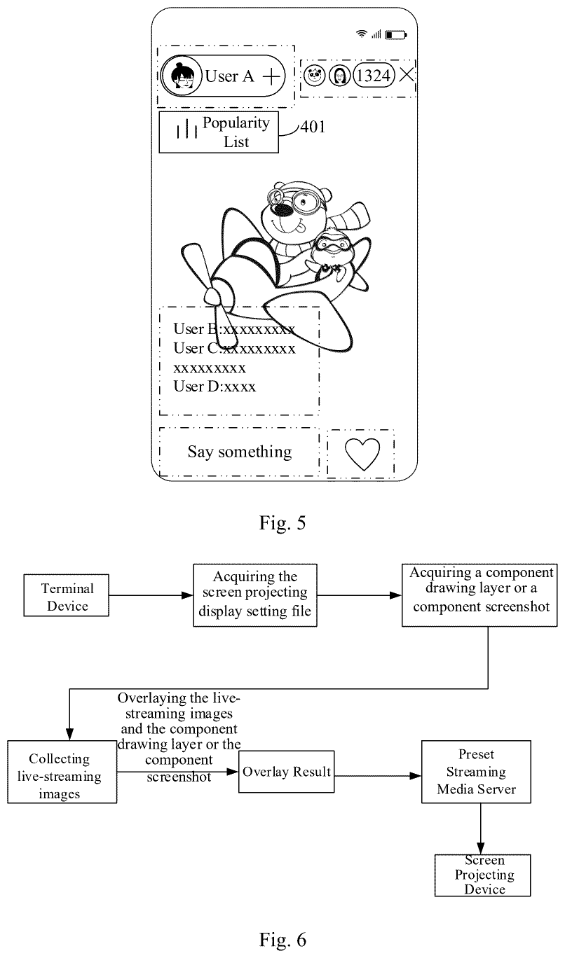

Referring to FIG. 4, which is a schematic diagram of a component circling selection page of a live-streaming room provided by an embodiment of the present disclosure, as shown in FIG. 4, each live-streaming room component corresponds to a circling selection box containing a circling selection range, for example, the circling selection box corresponding to a popularity list is a circling selection box 401, the display status of the circling selection box is a dotted line, which indicates that after the popularity list starts screen projecting, the screen projecting status is the screen projecting hidden status, namely, the popularity list is not displayed in the screen projecting image; after the user clicks the circling selection box 401, the display status of the circling selection box can be switched, the screen projecting display setting operation is triggered, so that the screen projecting status of the live-streaming room component can be switched, as shown in FIG. 5, the display status of the circling selection box 401 is switched to a solid line, which indicates that the current screen projecting status of the popularity list is switched to a screen projecting start status; and after user finishes circling selection, the screen projecting display setting file corresponding to the live-streaming room is generated.

In addition, after the screen projecting display setting operation of the user for the status to be set of the at least one live-streaming room component is received, and the screen projecting display setting file corresponding to the target live-streaming room page is generated, the screen projecting display setting file can be uploaded to a preset cloud server.

The preset cloud server can be selected as required, and no limitation is made here by the present disclosure.

Way I, after the screen projecting display setting operation of the user for the status to be set of the at least one live-streaming room component is received, and the screen projecting display setting file corresponding to the target live-streaming room page is generated, the corresponding relationship between the current object identifier and the screen projecting display setting file is uploaded to the preset cloud server.

The screen projecting display setting file is used for controlling screen projecting display of the live-streaming room page corresponding to an object with the current object identifier.

The current object identifier may include an account number of a current watcher and the like, and no limitation is made here by the present disclosure.

In the embodiment of the present disclosure, after the corresponding relationship between the current object identifier and the screen projecting display setting file is uploaded to the preset cloud server, the user can acquire the screen projecting display setting file corresponding to the user with the current object identifier from the preset cloud server based on the current object identifier when the live-streaming room page is screen projected again by the user subsequently.

Way 2, after the screen projecting display setting operation of the user for the status to be set of the at least one live-streaming room component is received, and the screen projecting display setting file corresponding to the target live-streaming room page is generated, a corresponding relationship between a live-streaming room type corresponding to the target live-streaming room page and the screen projecting display setting file is established, and the live-streaming room type and screen projecting display setting file having the corresponding relationship are uploaded to the preset cloud server.

The screen projecting display setting file is used for controlling the screen projecting display of the live-streaming room page corresponding to the live-streaming room type.

In the embodiment of the present disclosure, after the live-streaming room type and screen projecting display setting file having the corresponding relationship are uploaded to the preset cloud server, and in response to the live-streaming room page is projected by the user again, the screen projecting display setting file corresponding to the live-streaming room type can be acquired from the preset cloud server based on the current live-streaming room type.

Way 3, after the screen projecting display setting operation of the user for the status to be set of the at least one live-streaming room component is received, and the screen projecting display setting file corresponding to the target live-streaming room page is generated, a corresponding relationship between the live-streaming room identifier corresponding to the target live-streaming room page and the screen projecting display setting file is established, and the live-streaming room identifier and screen projecting display setting file having the corresponding relationship are uploaded to the preset cloud server.

The screen projecting display setting file is used for controlling the screen projecting display of the live-streaming room page with the live-streaming room identifier.

In the embodiment of the present disclosure, after the live-streaming room identifier and the screen projecting display setting file having the corresponding relationship are uploaded to the preset cloud server, and in response to the live-streaming room page being projected by the user again, the screen projecting display setting file corresponding to the live-streaming room identifier can be acquired from the preset cloud server based on the current live-streaming room identifier.

In another optional implementation, in response to the triggering operation for the screen projecting setting control of the target live-streaming room page, the screen projecting display setting file corresponding to the target live-streaming room page is acquired from the preset cloud server.

In the embodiment of the present disclosure, after the triggering operation for the screen projecting setting control of the target live-streaming room page is received, the screen projecting display setting file corresponding to the target live-streaming room page is acquired from the preset cloud server, in which the screen projecting display setting file stored in the preset cloud server can be the screen projecting display setting file pre-stored by a third party, and can also be the screen projecting display setting file uploaded by the user, no limitation is made here by the present disclosure.

S102, controlling the target live-streaming room page to perform screen-projecting display based on the screen projecting status corresponding to each live-streaming room component in the screen projecting display setting file.

In the embodiment of the present disclosure, after the triggering operation for the screen projecting setting control of the target live-streaming room page is received, the screen projecting display setting file corresponding to the target live-streaming room page is acquired, and then the screen projecting status corresponding to each live-streaming room component in the target live-streaming room page is determined from the screen projecting display setting file, thereby controlling the target live-streaming room page to perform screen-projecting display based on the screen projecting status.

In an optional implementation, based on the screen projecting status corresponding to each live-streaming room component in the screen projecting display setting file, the target live-streaming room page is controlled to carry out screen projecting display; it can be done based on the screen projecting status corresponding to one or more live-streaming room components included in the target live-streaming room page in the screen projecting display setting file, the one or more live-streaming room components on the live-streaming room page are controlled to carry out screen projecting display according to the screen projecting status of the one or more live-streaming room components in the screen projecting setting file, so that the screen projecting status of the one or more live-streaming room components on the target live-streaming room page displayed after screen projecting is consistent with the screen projecting status of the one or more live-streaming room components in the screen projecting display setting file. In an optional implementation, in response to determine the current status being a mirror screen projecting mode, the target live-streaming room page is drawn based on the screen projecting status corresponding to each live-streaming room component in the screen projecting display setting file, so as to obtain a first drawing result, and the first drawing result is transmitted to the screen projecting device. The screen projecting device is configured to display the first drawing result.

Specifically, the screen projecting device can be a television, a projector, and other terminals with large display screens, and the size of a display screen of the screen projecting device is generally larger than that of the terminal device.

The mirror screen projecting refers to transmitting the content displayed by a screen projecting end device to the screen projected device, so that the screen projected device displays the display content which is the same as that of a screen projecting end.

In the embodiment of the present disclosure, the live-streaming room component used to draw on the target live-streaming room page is a live-streaming room component with the screen projecting status as the screen projecting display status.

In another optional implementation, in response to determine the current status being in a digital living network alliance (DLNA) screen projecting mode, based on the screen projecting status corresponding to each live-streaming room components in the screen projecting display setting file, a component drawing layer or a component screenshot of the target live-streaming room page is acquired according to a preset frequency; and overlaying the collected live-streaming image of the target live-streaming room page and the component drawing layer or the component screenshot, so as to obtain an overlay result, the overlay result is transmitted to a preset streaming media server, and then the screen projecting device pulls the overlay result from the preset streaming media server based on the pre-acquired streaming media server address to display.

The live-streaming room component on the target live-streaming room page is drawn on the component drawing layer, and the component screenshot carries page location information.

DLNA screen projecting refers to that, in the same network, a screen projecting end transmits a resource link of display content to the screen projecting device, and the screen projecting device acquires the link through the network, so that the display content of the screen projecting end is displayed.

The preset frequency can be set based on requirements, for example, it can be set to be 5 frames, 10 frames, and the like, and no limitation is made here by the present disclosure.

The preset streaming media server refers to a server configured to transmit streaming media data. In the embodiment of the present disclosure, in response to a plurality of component drawing layers of the target live-streaming room page being acquired, the overlay processing can be carried out based on a display sequence of the component drawing layers.

In the embodiment of the present disclosure, in response to determine the current status being the DLNA screen projecting mode, based on the screen projecting status corresponding to each live-streaming room component in the screen projecting display setting file, the component screenshot of the target live-streaming room page is acquired according to thee preset frequency; according to the page location information carried by the component screenshot, the overlay processing is carried out on the collected live streaming image of the target live-streaming room page in the preset streaming media server and the component screenshot, so as to obtain an overlay result, the overlay result is transmitted to the preset streaming media server, and then the screen projecting device pulls the overlay result from the preset streaming media server based on the pre-acquired streaming media server address to display.

In order to understand the embodiments of the present disclosure more clearly, referring to FIG. 6, which is a flowchart of DLNA screen projecting provided by an embodiment of the present disclosure, specifically, after the triggering operation for the screen projecting setting control of the target live-streaming room page in the terminal device is received, the screen projecting display setting file corresponding to the target live-streaming room page is acquired; in response to determine the current status being a DLNA screen projecting mode, based on the screen projecting status corresponding to each live-streaming room component in the screen projecting display setting file, the component drawing layer or the component screenshot of the target live-streaming room page is acquired according to the preset frequency; then, live streaming images of the target live-streaming room page are collected; and an overlay processing is carried out on the collected live streaming images of the target live-streaming room page and the component drawing layer or the component screenshot, and obtaining an overlay result; and the overlay result is transmitted to the preset streaming media server, and then the screen projecting device can pull the overlay result from the preset streaming media server based on the pre-acquired streaming media server address to display.

Based on the above implementations, after the screen projecting display is carried out for the target live-streaming room page, and in response to that other live-streaming room pages need to be screen projected, the screen projecting display can be controlled based on the screen projecting display setting file corresponding to the target live-streaming room page; specifically, in response to a preset live-streaming room switching operation for the target live-streaming room page, the target live-streaming room page is switched and displayed to a switched live-streaming room page corresponding to the preset live-streaming room switching operation, and the switched live-streaming room page is controlled to perform screen-projecting display based on the screen projecting display setting file corresponding to the target live-streaming room page.

The preset live-streaming room switching operation can be a live-streaming room up-slide operation and a live-streaming room down-slide operation, and no limitation is made here by the present disclosure.

In the embodiment of the present disclosure, after the live-streaming room up-slide operation for the target live-streaming room page is received, the target live-streaming room page is switched and displayed to the switched live-streaming room page corresponding to the live-streaming room up-slide operation, and the screen projecting display setting file corresponding to the target live-streaming room page is acquired; and the switched live-streaming room page is controlled to perform screen-projecting display by the screen projecting display setting file corresponding to the target live-streaming room page.

In the screen projecting processing method provided by the embodiment of the present disclosure, firstly, in response to the triggering operation for the screen projecting setting control of the target live-streaming room page, the screen projecting display setting file corresponding to the target live-streaming room page is acquired, in which the screen projecting display setting file includes the mapping relationship between the live-streaming room component and a screen projecting status, the screen projecting status is the screen projecting display status or the screen projecting hidden status, and the target live-streaming room page is controlled to perform screen-projecting display based on the screen projecting status corresponding to each live-streaming room component in the screen projecting display setting file. Therefore, in the embodiment of the present disclosure, the screen projecting display of the target live-streaming room page can be controlled based on the screen projecting status corresponding to each live-streaming room component in the screen projecting display file corresponding to the target live-streaming room page, the effect of screen projecting for the live-streaming room components in the live streaming scene screen projecting function is enriched, and the screen projecting experience of the user in the live streaming scenario is improved.

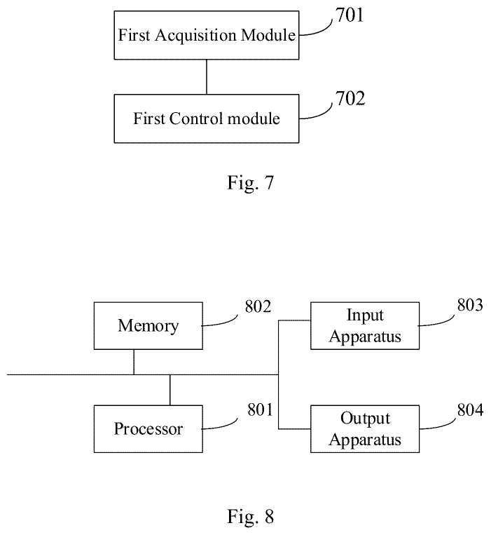

Corresponding to the above embodiments of the method, the present disclosure also provides a screen projecting processing apparatus, referring to FIG. 7, which is a schematically structural diagram of a screen projecting processing apparatus provided by the embodiment of the present disclosure, and the apparatus includes following structures.

A first acquisition module 701 which is configured to acquire a screen projecting display setting file corresponding to a target live-streaming room page in response to a triggering operation for a screen projecting setting control of the target live-streaming room page, in which the screen projecting display setting file includes a mapping relationship between each live-streaming room component and a screen projecting status, the screen projecting status is a screen projecting display status or a screen projecting hidden status; and

A first control module 702 which is configured to control the target live-streaming room page to perform screen-projecting display based on the screen projecting status corresponding to the live-streaming room component in the screen projecting display setting file.

In an optional implementation, the first acquisition module includes:

a display module which is configured to: in response to the triggering operation for the screen projecting setting control of the target live-streaming room page, display a status to be set of at least one live streaming component on the target live-streaming room page;

a second acquisition module which is configured to: in response to the screen projecting display setting operation for the status to be set of the at least one live-streaming room component, acquire the screen projecting display setting file corresponding to the target live-streaming room page.

In an optional implementation, the first acquisition module is specifically configured to: in response to the triggering operation for the screen projecting setting control of the target live-streaming room page, acquire the screen projecting display setting file corresponding to the target live-streaming room page from a preset cloud server.

In an optional implementation, the first control module includes: a drawing module which is configured to: in response to determine the current status being a mirror image screen projecting mode, draw the target live-streaming room page based on the screen projecting status corresponding to the each live-streaming room component in the screen projecting display setting file, so as to obtain a first drawing result;

a first transmission module which is configured to transmit the first drawing result to a screen projecting device, in which the screen projecting device is configured to display the first drawing result.

In an optional implementation, characterized in that the first control module includes:

a third acquisition module which is configured to: in response to determine the current status being a digital living network alliance (DLNA) screen projecting mode, based on the screen projecting status corresponding to each live-streaming room component in the screen projecting display setting file, acquire a component drawing layer or a component screenshot of the target live-streaming room page according to a preset frequency, in which the live-streaming room component on the target live-streaming room page is drawn on the component drawing layer, and the component screenshot carries page location information;

an overlay module which is configured to overlay the collected live streaming image of the target live-streaming room page and the component drawing layer or the component screenshot, so as to obtain an overlay result;

a second transmission module which is configured to transmit the overlay result to a preset streaming media server, so that the screen projecting device pulls the overlay result from the preset streaming media server based on the pre-acquired streaming media server address to display.

In an optional implementation, the apparatus further includes:

a first uploading module which is configured to unload a corresponding relationship between a current object identifier and the screen projecting display setting file to the preset cloud server; and the screen projecting display setting file is used for controlling screen projecting display of the live-streaming room page corresponding to an object with the current object identifier.

In an optional implementation, the apparatus further includes:

a first establishment module which is configured to establish a corresponding relationship between a live-streaming room type corresponding to the target live-streaming room page and the screen projecting display setting file; and

a second uploading module which is configured to unload the live-streaming room type and screen projecting display setting file having the corresponding relationship to the preset cloud server; and the screen projecting display setting file is used for controlling screen projecting display of the live-streaming room page corresponding to the live-streaming room type.

In an optional implementation, the apparatus further includes:

a second establishment module which is configured to establish the corresponding relationship between the live-streaming room identifier corresponding to the target live-streaming room page and the screen projecting display setting file; and

a third uploading module which is configured to upload the live-streaming room identifier and the screen projecting display setting file having the corresponding relationship to the preset cloud server; and screen projecting display setting file is used for controlling the screen projecting display of the live-streaming room page with the live-streaming room identifier.

In an optional implementation, the apparatus further includes:

a switching module which is configured to: in response to a preset live-streaming room switching operation for the target live-streaming room page, switch and display the target live-streaming room page to a switched live-streaming room page corresponding to the preset live-streaming room switching operation; and

a second control module which is configured to control the switched live-streaming room page to perform screen-projecting display based on the screen projecting display setting file corresponding to the target live-streaming room page.

In the screen projecting processing apparatus provided by the embodiment of the present disclosure, firstly, in response to the triggering operation for the screen projecting setting control of the target live-streaming room page, the screen projecting display setting file corresponding to the target live-streaming room page is acquired, in which the screen projecting display setting file includes the mapping relationship between each live-streaming room component and a screen projecting status, the screen projecting status is the screen projecting display status or the screen projecting hidden status, and the target live-streaming room page is controlled to perform screen-projecting display based on the screen projecting status corresponding to each live-streaming room component in the screen projecting display setting file. Therefore, in the embodiment of the present disclosure, the screen projecting display of the target live-streaming room page can be controlled based on the screen projecting status corresponding to each live-streaming room component in the screen projecting display file corresponding to the target live-streaming room page, the effect of screen projecting for the live-streaming room components in the live streaming scene screen projecting function is enriched, and the screen projecting experience of the user in the live streaming scenario is improved.

In addition to the above method and apparatus, an embodiment of the present disclosure also provides a computer-readable storage medium, in which instructions are stored; and a terminal device implements the screen projecting processing method described in the embodiment of the present disclosure upon the instructions being run on the terminal device.

An embodiment of the present disclosure also provides a computer program product, which includes a computer program/instructions; and the screen projecting processing method described in the embodiments of the present disclosure is implemented upon the computer program/instructions being executed by a processor.

In addition, an embodiment of the present disclosure also provides a screen projecting processing device, referring to FIG. 8, the device can includes:

a processor 801, a memory 802, an input apparatus 803, and an output apparatus 804. One or more processors 801 can be provided in the screen projecting processing device, and as an example, in FIG. 8, one processor is provided. In some embodiments of the present disclosure, the processor 801, the memory 802, the input apparatus 803, and the output apparatus 804 can be connected through a bus or in other ways, and the bus connection is used in FIG. 8 as an example.

The memory 802 can be configured to store software programs and modules, and the processor 801 runs the software programs and the modules stored in the memory 802, so that various function applications and screen projecting processing of the screen projecting processing device are realized. The memory 802 can mainly include a storage program area and a storage data area, in which the storage program area can store an operating system, an application or the like required by at least one function. In addition, the memory 802 can include a high-speed random access memory and can also include a non-volatile memory, such as at least one disk storage device, a flash memory device, or other volatile solid-status storage devices. The input apparatus 803 can be configured to receive input digital or character information, and generate signal input related to user setting and function control of the screen projecting processing device.

Specifically, in the embodiment, the processor 801 loads an executable file corresponding to the process of one or more applications into the memory 802 according to the following instructions, and the processor 801 runs the applications stored in the memory 802, so that various functions of the screen projecting processing device are implemented.

Herein, it is to be noted that relationship terms, such as ‘first’ and ‘second,’ are only used to distinguish one entity or operation from another entity or operation, and do not necessarily require or imply any actual relationship or order between these entities or operations. Moreover, the terms ‘comprising’, ‘including’, or any other variation thereof, are intended to encompass non-exclusive inclusion, such that a process, method, item, or device that includes a series of elements includes not only those elements, but also other elements not explicitly listed, or elements inherent to such process, method, item, or device. Without further limitations, the element defined by the statement ‘including a . . . ’ does not exclude existence of other identical elements in the process, method, item, or device that includes this element.

The above description are only specific implementations of the present disclosure, which enables those skilled in the art to understand or implement the present disclosure. Various modifications to these embodiments will be apparent to those skilled in the art, and the general principles defined herein can be implemented in other embodiments without departing from the spirit or scope of the present disclosure. Therefore, the present disclosure will not be limited to the embodiments described herein, but will be the widest scope consistent with the principles and novel features disclosed herein.

1. A screen projecting processing method, comprising:
acquiring a screen projecting setting file corresponding to a target live-streaming page in response to a triggering operation for a screen projecting setting control of the target live-streaming page, in which the screen projecting setting file comprises a mapping relationship between each live-streaming component and a screen projecting status, the screen projecting status is a screen projecting display status or a screen projecting hidden status; and
controlling the target live-streaming page to perform screen-projecting display based on the screen projecting status corresponding to the each live-streaming component in the screen projecting setting file.

2. The screen projecting processing method according to claim 1, wherein the acquiring the screen projecting setting file corresponding to the target live-streaming page in response to the triggering operation for the screen projecting setting control of the target live-streaming page comprises:
displaying a status to be set of at least one live streaming component on the target live-streaming page in response to the triggering operation for the screen projecting setting control of the target live-streaming page; and
acquiring the screen projecting setting file corresponding to the target live-streaming page in response to the screen projecting display setting operation for the status to be set of the at least one live-streaming component.

3. The screen projecting processing method according to claim 1, wherein the acquiring the screen projecting setting file corresponding to the target live-streaming page in response to the triggering operation for the screen projecting setting control of the target live-streaming page comprises:
acquiring the screen projecting setting file corresponding to the target live-streaming page from a preset cloud server in response to the triggering operation for the screen projecting setting control of the target live-streaming page.

4. The screen projecting processing method according to claim 1, wherein the controlling the target live-streaming page to perform screen-projecting display based on the screen projecting status corresponding to the each live-streaming component in the screen projecting setting file comprises:
in response to determine a current status being in a mirror screen projecting mode, drawing the target live-streaming page based on the screen projecting status corresponding to the each live-streaming component in the screen projecting setting file, and obtaining a first drawing result; and
transmitting the first drawing result to a screen projecting device, and indicating the screen projecting device to display the first drawing result.

5. The screen projecting processing method according to claim 1, wherein the controlling the target live-streaming page to perform screen-projecting display based on the screen projecting status corresponding to the each live-streaming component in the screen projecting setting file comprises:
in response to determine a current status being a digital living network alliance (DLNA) screen projecting mode, based on the screen projecting status corresponding to the each live-streaming component in the screen projecting setting file, acquiring a component drawing layer or a component screenshot of the target live-streaming page according to a preset frequency, in which the live-streaming component on the target live-streaming page is drawn on the component drawing layer, and the component screenshot carries page location information;
overlaying the collected live streaming image of the target live-streaming page and the component drawing layer or the component screenshot, and obtaining an overlay result; and
transmitting the overlay result to a preset streaming media server, and indicating the screen projecting device to pull the overlay result from the preset streaming media server based on a pre-acquired streaming media server address to display.

6. The screen projecting processing method according to claim 2, wherein, after acquiring the screen projecting setting file corresponding to the target live-streaming page in response to the screen projecting display setting operation for the status to be set of the at least one live-streaming component, the screen projecting processing method further comprises:
unloading the corresponding relationship between a current object identifier and the screen projecting setting file to a preset cloud server; and the screen projecting setting file is used for controlling screen projecting display of the live-streaming page corresponding to an object with the current object identifier.

7. The screen projecting processing method according to claim 2, wherein, after acquiring the screen projecting setting file corresponding to the target live-streaming page in response to the screen projecting display setting operation for the status to be set of the at least one live-streaming component, the screen projecting processing method further comprises:
establishing a corresponding relationship between a live-streaming type corresponding to the target live-streaming page and the screen projecting setting file; and
unloading the live-streaming type and the screen projecting setting file having the corresponding relationship to a preset cloud server; and the screen projecting setting file is used for controlling screen projecting display of the live-streaming page corresponding to the live-streaming room type.

8. The screen projecting processing method according to claim 2, wherein, after acquiring the screen projecting setting file corresponding to the target live-streaming room page in response to the screen projecting display setting operation for the status to be set of the at least one live-streaming component, the screen projecting processing method further comprises:
establishing a corresponding relationship between a live-streaming room identifier corresponding to the target live-streaming page and the screen projecting setting file; and
uploading the live-streaming room identifier and screen projecting setting file having the corresponding relationship to a preset cloud server; and the screen projecting setting file is used for controlling the screen projecting display of the live-streaming page with the live-streaming room identifier.

9. The screen projecting processing method according to claim 1, wherein, after controlling the target live-streaming page to perform screen-projecting display based on the screen projecting status corresponding to the each live-streaming component in the screen projecting setting file, the screen projecting processing method further comprises:
in response to a preset live-streaming room switching operation for the target live-streaming page, switching and displaying the target live-streaming room page to a switched live-streaming page corresponding to the preset live-streaming switching operation; and
controlling the switched live-streaming page to perform screen-projecting display based on the screen projecting setting file corresponding to the target live-streaming page.

10. A screen projecting processing apparatus, comprising:
a first acquisition module configured to: acquire a screen projecting setting file corresponding to a target live-streaming page in response to a triggering operation for a screen projecting setting control of the target live-streaming page, in which the screen projecting setting file comprises a mapping relationship between each live-streaming component and a screen projecting status, the screen projecting status is a screen projecting display status or a screen projecting hidden status; and
a first control module configured to control the target live-streaming page to perform screen-projecting display based on the screen projecting status corresponding to the each live-streaming component in the screen projecting setting file.

11. A non-transitory computer-readable storage medium, wherein instructions are stored, a terminal device implements the screen projecting processing method according to claim 1 upon the instructions running on the terminal device.

12. A screen projecting processing device, comprising, a memory, a processor, and a computer program which is stored in the memory and can run in the processor, wherein, upon the computer program being performed by the processor, cause the processor to:
acquire a screen projecting setting file corresponding to a target live-streaming page in response to a triggering operation for a screen projecting setting control of the target live-streaming page, in which the screen projecting setting file comprises a mapping relationship between each live-streaming component and a screen projecting status, the screen projecting status is a screen projecting display status or a screen projecting hidden status; and
control the target live-streaming page to perform screen-projecting display based on the screen projecting status corresponding to the each live-streaming component in the screen projecting setting file.

13. A computer program product, comprising a computer program/instructions, wherein the method according to claim 1 is implemented upon the computer program/instructions being executed by a processor.

14. The screen projecting processing method according to claim 2, wherein the controlling the target live-streaming page to perform screen-projecting display based on the screen projecting status corresponding to the each live-streaming component in the screen projecting setting file comprises:
in response to determine a current status being in a mirror screen projecting mode, drawing the target live-streaming page based on the screen projecting status corresponding to the each live-streaming component in the screen projecting setting file, and obtaining a first drawing result; and
transmitting the first drawing result to a screen projecting device, and indicating the screen projecting device to display the first drawing result.

15. The screen projecting processing method according to claim 3, wherein the controlling the target live-streaming page to perform screen-projecting display based on the screen projecting status corresponding to the each live-streaming component in the screen projecting setting file comprises:
in response to determine a current status being in a mirror screen projecting mode, drawing the target live-streaming page based on the screen projecting status corresponding to the each live-streaming component in the screen projecting setting file, and obtaining a first drawing result; and
transmitting the first drawing result to a screen projecting device, and indicating the screen projecting device to display the first drawing result.

16. The screen projecting processing method according to claim 2, wherein the controlling the target live-streaming page to perform screen-projecting display based on the screen projecting status corresponding to the each live-streaming component in the screen projecting setting file comprises:
in response to determine a current status being a digital living network alliance (DLNA) screen projecting mode, based on the screen projecting status corresponding to the each live-streaming component in the screen projecting setting file, acquiring a component drawing layer or a component screenshot of the target live-streaming page according to a preset frequency, in which the live-streaming component on the target live-streaming page is drawn on the component drawing layer, and the component screenshot carries page location information;
overlaying the collected live streaming image of the target live-streaming page and the component drawing layer or the component screenshot, and obtaining an overlay result; and
transmitting the overlay result to a preset streaming media server, and indicating the screen projecting device to pull the overlay result from the preset streaming media server based on a pre-acquired streaming media server address to display.

17. The screen projecting processing method according to claim 3, wherein the controlling the target live-streaming page to perform screen-projecting display based on the screen projecting status corresponding to the each live-streaming component in the screen projecting setting file comprises:
in response to determine a current status being a digital living network alliance (DLNA) screen projecting mode, based on the screen projecting status corresponding to the each live-streaming component in the screen projecting setting file, acquiring a component drawing layer or a component screenshot of the target live-streaming page according to a preset frequency, in which the live-streaming component on the target live-streaming page is drawn on the component drawing layer, and the component screenshot carries page location information;
overlaying the collected live streaming image of the target live-streaming page and the component drawing layer or the component screenshot, and obtaining an overlay result; and
transmitting the overlay result to a preset streaming media server, and indicating the screen projecting device to pull the overlay result from the preset streaming media server based on a pre-acquired streaming media server address to display.

18. The screen projecting processing method according to claim 2, wherein, after controlling the target live-streaming page to perform screen-projecting display based on the screen projecting status corresponding to the each live-streaming component in the screen projecting setting file, the screen projecting processing method further comprises:
in response to a preset live-streaming room switching operation for the target live-streaming page, switching and displaying the target live-streaming page to a switched live-streaming page corresponding to the preset live-streaming room switching operation; and
controlling the switched live-streaming page to perform screen-projecting display based on the screen projecting setting file corresponding to the target live-streaming page.

19. The screen projecting processing method according to claim 3, wherein, after controlling the target live-streaming page to perform screen-projecting display based on the screen projecting status corresponding to the each live-streaming component in the screen projecting setting file, the screen projecting processing method further comprises:
in response to a preset live-streaming room switching operation for the target live-streaming page, switching and displaying the target live-streaming page to a switched live-streaming page corresponding to the preset live-streaming room switching operation; and
controlling the switched live-streaming page to perform screen-projecting display based on the screen projecting setting file corresponding to the target live-streaming page.

20. The screen projecting processing method according to claim 4, wherein, after controlling the target live-streaming page to perform screen-projecting display based on the screen projecting status corresponding to the each live-streaming component in the screen projecting setting file, the screen projecting processing method further comprises:
in response to a preset live-streaming room switching operation for the target live-streaming page, switching and displaying the target live-streaming page to a switched live-streaming page corresponding to the preset live-streaming room switching operation; and
controlling the switched live-streaming page to perform screen-projecting display based on the screen projecting setting file corresponding to the target live-streaming page.
